(19) United States
(12) Patent Application Publication
(10) Pub. No.: US 2026/0079099 A1
(43) Pub. Date: Mar. 19, 2026

(54) Multipass hydrogenated palladium optical cavities for detection of hydrogen

(71) Applicant: Indrio Technologies, Inc., Riverside, CA (US)

(72) Inventor: Ritobrata Sur, Riverside, CA (US)

(21) Appl. No.: 19/108,622

(22) PCT Filed: Sep. 14, 2023
(86) PCT No.: PCT/US2023/032802

§ 371 Date: Mar. 4, 2025

Related U.S. Application Data
(60) Provisional application No. 63/408,040, filed on Sep. 19, 2022.

(51) Int. Cl. G01N 21/03; G01N 21/25; G01N 21/3504

(52) U.S. Cl. CPC G01N 21/031; G01N 21/255; G01N 21/3504; G01N 2021/0389

(57) ABSTRACT

A device for measuring concentration of hydrogen in a gas sample comprises a multipass optical cavity having optical elements including mirrors supporting a multipass optical pathway inside the multipass optical cavity. A laser is configured to generate a laser beam that propagates along the multipass optical pathway, reflecting multiple times from the mirrors. An intensity of the laser beam exiting the multipass optical cavity is detected, and a signal processor determines the concentration of hydrogen in the gas sample in the optical cavity from a measured intensity of the laser beam. The optical elements may also include one or more transmissive windows.

### FIELD OF THE INVENTION

The present invention relates generally to methods and devices for detecting hydrogen gas. More specifically, it relates to hydrogen gas sensing using optical methods.

### BACKGROUND OF THE INVENTION

Hydrogen is one of the most important fuels in a fossil-free energy future. One of the biggest challenges in developing a hydrogen-based infrastructure is the fact that hydrogen gas is explosive and extremely prone to leaks. To help address this challenge, considerable research is underway to detect hydrogen gas leaks.

One active approach to hydrogen sensing uses palladium-hydrogen (PdHx) materials. When exposed to hydrogen, palladium absorbs hydrogen and changes various physical properties, including its optical properties. The amount of change in its optical properties is dependent on the concentration of hydrogen present. This allows hydrogen concentration to be determined, for example, by measuring a decrease of intensity of light reflected from a mirror coated with palladium or transmitted through a tapered optical fiber coated with palladium. However, the sensitivity of these existing optical methods to detect hydrogen is limited to ppm-level detection. Despite attempts to develop improved palladium materials for these purposes, there is still a need for higher sensitivity in order to detect trace levels of hydrogen.

### SUMMARY OF THE INVENTION

The present invention provides a hydrogen sensor that is able to detect hydrogen at ppb or lower concentration levels. To dramatically improve the sensitivity of PdHx optical detection, a multipass optical cavity is used. A laser beam passes through free space within the cavity, experiencing a large number of reflections. Along its optical path within the cavity, the beam interacts many times with palladium-containing coatings on reflective and/or transmissive optical elements within the cavity. The coated optical elements are exposed to a gas within the free space within the cavity.

Multipass optical cavities have been used in gas detectors based on laser absorption spectroscopy. In these devices, the laser beam interacts directly with the gas along the free space path followed by the beam as it reflects between two mirrors. The mirrors serve to increase the free space path length, and do not play any active role in the sensing. In contrast with multipass optical cavities in laser absorption spectroscopy sensors, the multipass optical cavity of the present invention includes optical elements that play an active role in the sensing of the gas. Specifically, palladium materials coated on optical elements inside the cavities interact optically with the laser beam and are actively involved with the sensing of hydrogen gas in the cavity through hydrogenation of palladium. In this design, therefore, it is the number of interactions of the laser beam with these palladium-coated optical elements that serves to increase the sensor's sensitivity, rather than the free space path length. Thus, the mirrors can be positioned close to each other without reducing sensitivity, allowing for a compact design. The sensitivity of this sensor can be improved further by inserting optically transmissive materials coated with palladium within the cavity so as to intersect with the multipass path of the laser.

Thus, in one aspect, the invention provides a laser-based hydrogen sensor comprising: a) a laser adapted to generate a laser beam at an operational wavelength; b) an optical multi-reflection cavity comprising reflective optical elements with coatings containing Pd, and optionally further comprising transmissive optical elements with coatings containing Pd; c) optionally, a sealed gas chamber to confine a gas samples, where the sealed gas chamber has fittings to facilitate gas flow; d) a laser beam detector configured to detect the laser beam after having passed through the cavity, and e) a signal processor adapted to quantify hydrogen concentration in the sample within the cavity based on measurements from the laser beam detector. In some embodiments, the cell is equipped with porous walls to facilitate diffusion-based sampling and reduce particulate entrainment. In some embodiments, the gas chamber can also be fitted with a particulate filter or interfering gas-reduction catalysts to prevent degradation of the optical surfaces and reduce cross-species interference.

In another aspect, the invention provides a device for measuring a concentration of hydrogen in a gas sample, the device comprising: a multipass optical cavity comprising optical elements, wherein the optical elements include mirrors supporting a multipass optical pathway within an interior of the multipass optical cavity; a laser configured to generate a laser beam entering the multipass optical cavity and propagating along the multipass optical pathway within the interior of the multipass optical cavity such that the laser beam reflects multiple times from the mirrors of the multipass optical cavity; a detector configured to detect an intensity of the laser beam exiting the multipass optical cavity; and a signal processor configured to determine the concentration of hydrogen in the gas sample in the optical cavity from a measured intensity of the laser beam; wherein the multipass optical cavity comprises surface layers containing Pd on the optical elements; whereby hydrogenation of the surface layers containing Pd by the hydrogen in the gas sample alters optical properties of the surface layers containing Pd.

The surface layers containing Pd may comprise a Pd alloy with Au, Co, Ta, Ti, or Hf. The surface layers containing Pd may comprise nanoparticles or polymer coatings. The surface layers containing Pd may have thicknesses of 30 nm or 20 nm. The surface layers containing Pd may have thicknesses in the range 5 nm-200 nm. The surface layers containing Pd may have a 160 nm layer of 67% Pd and 33% Co or Au alloy.

The surface layers containing Pd may be on the mirrors. The surface layers containing Pd may be on a surface of a transmissive window positioned between the mirrors to intersect the multipass optical pathway, where the transmissive window is included among the optical elements. The transmissive window, for example, may be a contrast enhancement slide. The transmissive window may comprise a 2 nm thickness layer of Pd or an alloy of Pd. The transmissive window may comprise a PdₓCo₁₀₀₋ₓ coating, where x is in the range 50-100. The composition of the alloy may have a graded structure to enhance responsivity and faster response times. The transmissive window may be a semi-transparent glass slide coated with a nanoparticle layer containing Pd or an alloy with Au, Ti, Co, Ta, Hf, or W. The transmissive window may comprise nanoparticles or nanostructures with diameters in the range 50 nm-1000 nm, or 200 nm-500 nm. The transmissive window may comprise an anti-reflective coating. The transmissive window may comprise a polymer coating of PMMA and/or PTFE. The transmissive window may comprise a polymer coating less than 100 nm thick.

The mirrors may be configured such that the laser beam reflects at least 5 times from the mirrors of the multipass optical cavity, or more preferably at least 10 times from the mirrors of the multipass optical cavity, or even more preferably at least 66 times from the mirrors of the multipass optical cavity.

The multipass optical cavity may be contained in a cell having porous walls configured to facilitate diffusion-based sampling and reduce particulate entrainment. The multipass optical cavity may be contained in a sealed gas chamber. The sealed gas chamber may contain a particulate filter or interfering gas-reduction catalysts to prevent degradation of optical surfaces and reduce cross-species interference.

The laser beam may have a wavelength in the range 400-1000 nm. The laser beam may have a wavelength in the range 1000-8000 nm. The laser beam may have a wavelength of 5.051 μm. The laser beam may have a wavelength of 1300 nm or 1550 nm. The laser may be a mid-infrared laser. The laser may be a diode laser, a quantum cascade laser, or an interband cascade laser.

### BRIEF DESCRIPTION OF THE DRAWINGS

FIG. 1A. A schematic diagram illustrating a hydrogen detection system according to one embodiment of the invention.

FIG. 1B. Cross-sectional view of a multipass hydrogenated palladium optical cavity for use in a hydrogen sensor, according to an embodiment of the invention.

FIG. 2. Graph of transmissivity and reflectivity vs wavelength of a Pd—Au alloy with and without exposure to 4% hydrogen.

FIG. 3. Cross-sectional view of a multipass hydrogenated palladium optical cavity containing multiple transmission windows with coatings containing Pd, according to an embodiment of the invention.

FIG. 4. Perspective view of a mirror and cross-sectional views of two variants of a coating containing Pd on the surface of the mirror, according to an embodiment of the invention.

FIG. 5. Perspective view of a multipass hydrogenated palladium optical cavity containing two reflectors, illustrating the multipass propagation path between the reflectors, according to an embodiment of the invention.

FIG. 6. Perspective view of a multipass hydrogenated palladium optical cavity containing two transmission windows with coatings containing Pd, according to an embodiment of the invention.

FIG. 7A. A graph of reflectivity of Pd vs. wavelength showing that Pd reflectivity increases significantly in the infrared region.

FIG. 7B. A graph of absorbance vs. wavelength of different thin-film compatible polymers.

FIG. 7C. A graph of absorbance vs. wavelength showing a simulated infrared spectrum of H₂O and CO₂.

FIG. 8. A graph of absorbance vs. wavelength of water showing a chosen operational wavelength for hydrogen detection to avoid water interference.

### DETAILED DESCRIPTION

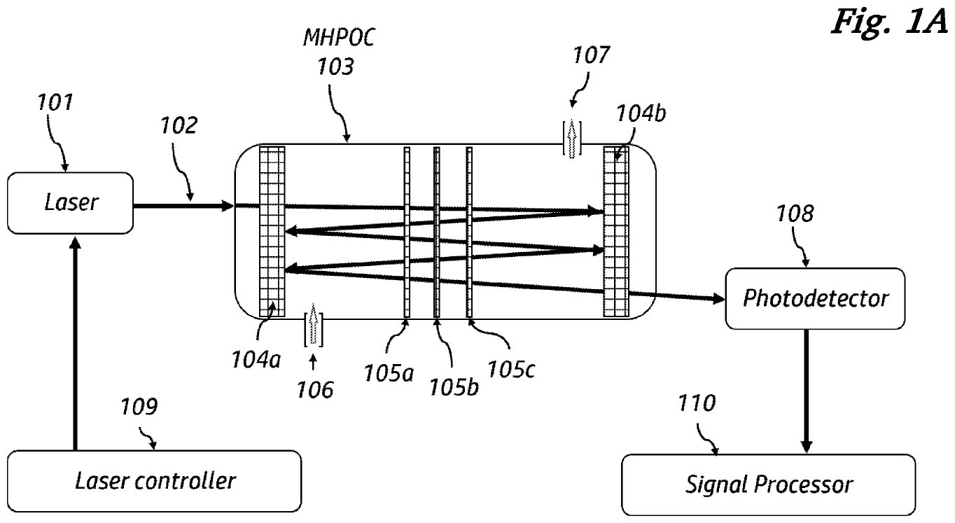

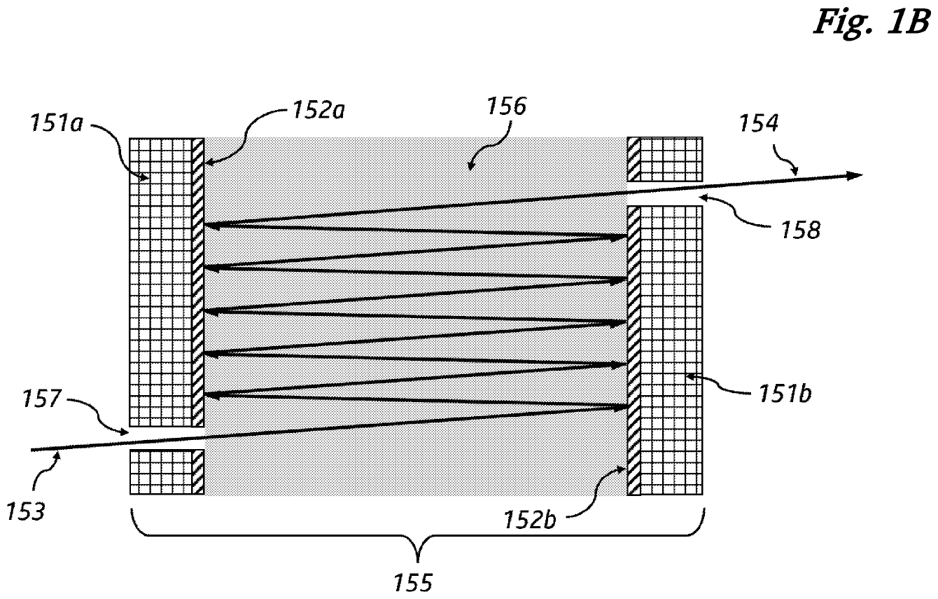

A hydrogen detection system according to one embodiment of the invention is shown in FIG. 1A. It includes a laser 101 emitting a beam 102, entering an optical cavity 103, bouncing between multiple mirrors 104a, 104b containing a special Pd coatings, exiting the optical cavity with the outlet beam intensity being measured by a photodetector 108. The sample gas enters the optical cavity 103, through a gas inlet 106 interacts with Pd coatings on various reflective 104a, 104b and transmissive 105a, 105b, 105c optical elements, and exits through the outlet 107.

The system also includes a laser controller 109 that controls the operation of laser 101. In addition to controlling the laser, the controller can control external temperatures of the cavity through resistive heaters or thermoelectric coolers. An active control of the cavity temperature enables improvement of the time response of the sensor even further since the absorption and desorption rates are significantly faster at elevated temperatures.

The system also includes a signal processor 110 that determines the hydrogen concentration from intensity measurements of photodetector 108. A sampling system such as a pump may be provided at the outlet 107 or a compressor may be provided at the inlet 106. The sampling system could also be replaced by an open path system, with the sensor operating at ambient pressure.

FIG. 1B shows a cross-sectional view of a multipass hydrogenated palladium optical cavity (MHPOC) according to one embodiment of the invention. The cavity has two or more mirrors 151a, 151b placed in an orientation such that a laser beam is reflected multiple times between the reflecting surfaces 152a, 152b. The reflecting surface of each mirror is composed of a thin film containing Pd or an alloy of Pd with Au, Co, Ta, Ti, Hf or W. The composition of the alloy may have a graded structure to enhance sensitivity without sacrificing its response time. The reflecting surface can also contain nanoparticles and polymer coatings as discussed later. A laser beam 153 enters through an inlet aperture 157 and reflects between surfaces 152a, 152b within a free-space region 156 between the mirrors, until an attenuated beam 154 exits the cavity through an aperture 158. The assembly of these components forms a version of the MHPOC as denoted by 155. The cavity can be enclosed in a gas-tight sampling chamber to allow for controlled flow of gas samples. The cavity can also remain an open path if the ambient conditions are appropriate to provide sufficient sensitivity.

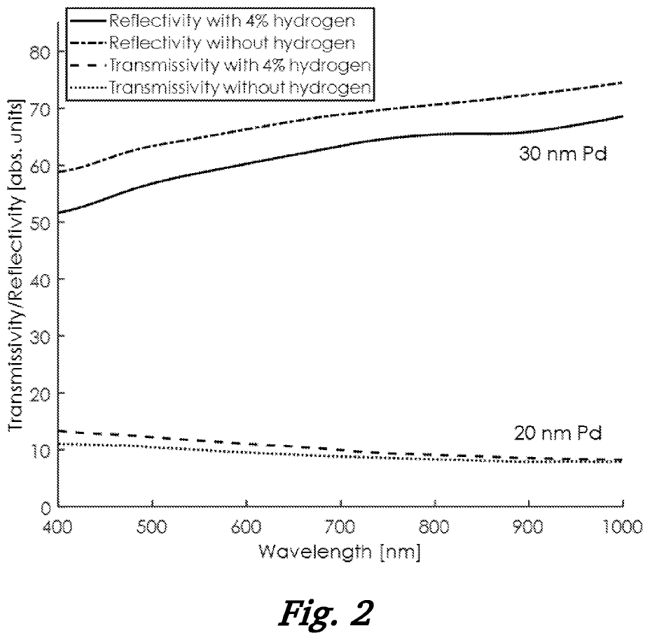

The fundamental principle behind MHPOC is the fact that material coatings containing Pd change in reflectance and transmittance when exposed to varying concentrations of hydrogen. Illustrating this dependency, FIG. 2 shows the reflectivities and transmissivities of a Pd—Au alloy in absence and presence of 4% H₂ in air for a wavelength range of 400-1000 nm. The reflectivities and transmissivities will also depend on the thickness, structure, and composition of the coating layer. The reflection and the transmission data shown here are for 30 nm and 20 nm layer thicknesses, respectively. As can be seen, the reflectivity reduces due to the presence of hydrogen and transmissivity increases due to the presence of hydrogen.

The hydrogen contrast (HC) in this embodiment is obtained from the equation

$$HC = \frac{Δ I}{I} = {( {R}_{0} )}^{n} - {( {R}_{H} )}^{n} \qquad ( 1 )$$

where ΔI is the change in light intensity at the outlet 154 of the cavity due to the presence of H₂, I is the intensity of light at the outlet 154 of the cavity without the presence of H₂, R₀ is the reflectivity of the mirrors without any exposure to hydrogen assuming uniform reflectivity of the two mirrors, R_{H} is the modified reflectivity of the mirrors in presence of hydrogen which is a function of hydrogen concentration, and n is the total number of reflections of the light beam between the two mirrors.

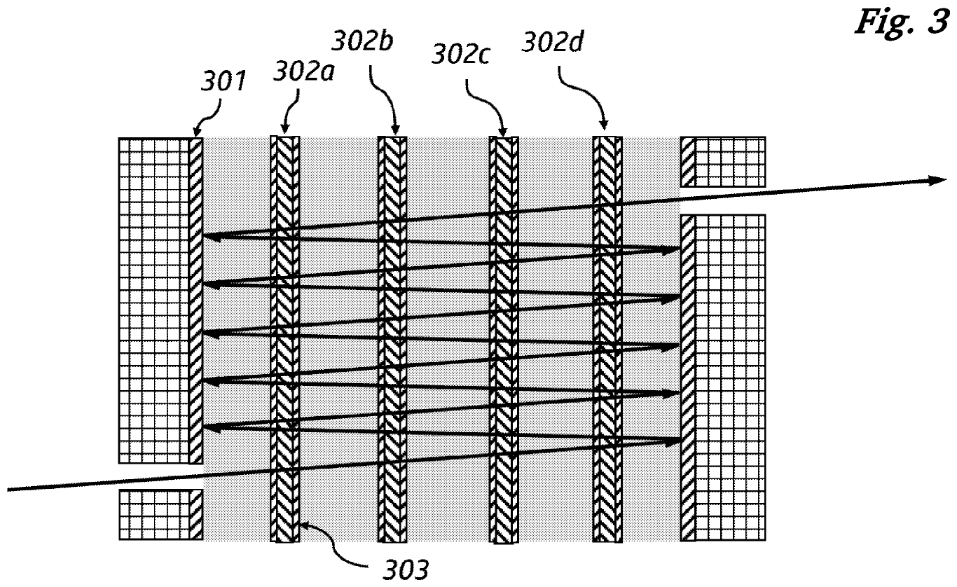

Another embodiment of the MHPOC is shown in FIG. 3. In this embodiment, multiple transmission windows 302a, 302b, 302c, 302d having Pd-containing coatings are inserted in the optical path to increase the sensitivity of the sensor to trace amounts of hydrogen. These transmission windows have a substrate such as fused silica or other optically transparent materials, and a coating 303 containing Pd on one or both sides. The mirror coating 301 can be the same as in the previously discussed embodiment. The hydrogen contrast for this variant with nr number of transmission windows can be expressed as

$$HC = \frac{Δ I}{I} = {( {( {T}_{0} )}^{{n}_{T}} {R}_{0} )}^{n} - {( {( {T}_{H} )}^{{n}_{T}} {R}_{H} )}^{n} \qquad ( 2 )$$

where T₀ is the transmissivity of the windows 302a, 302b, 302c, 302d in the absence of hydrogen, assuming all the windows have identical coatings, and T_{H} is the transmissivity of the windows 302a, 302b, 302c, 302d in presence of hydrogen. It can be emphasized that the transmission windows can have two coated surfaces containing Pd, and therefore can increase the sensitivity of the sensors significantly with fewer passes. However, this comes at a cost of transmission losses through the substrates which are typically higher than reflection losses. This can be compensated by using a higher power laser or a higher sensitivity photodetector or application of an antireflective (AR) coating.

In a variation of this embodiment, the mirror coating 301 may be a high-reflectivity mirror coating with no Pd, in which case the transmission windows provide the entirety of the hydrogen signal contrast. In this special case of the reflectors being chosen to be a high reflectivity hydrogen-invariant reflection material, the hydrogen contrast equation simplifies to

$$HC = \frac{Δ I}{I} = {R}_{0}^{n} [ {( {T}_{0} )}^{n {n}_{T}} - {( {T}_{0} )}^{n {n}_{T}} ] \qquad ( 3 )$$

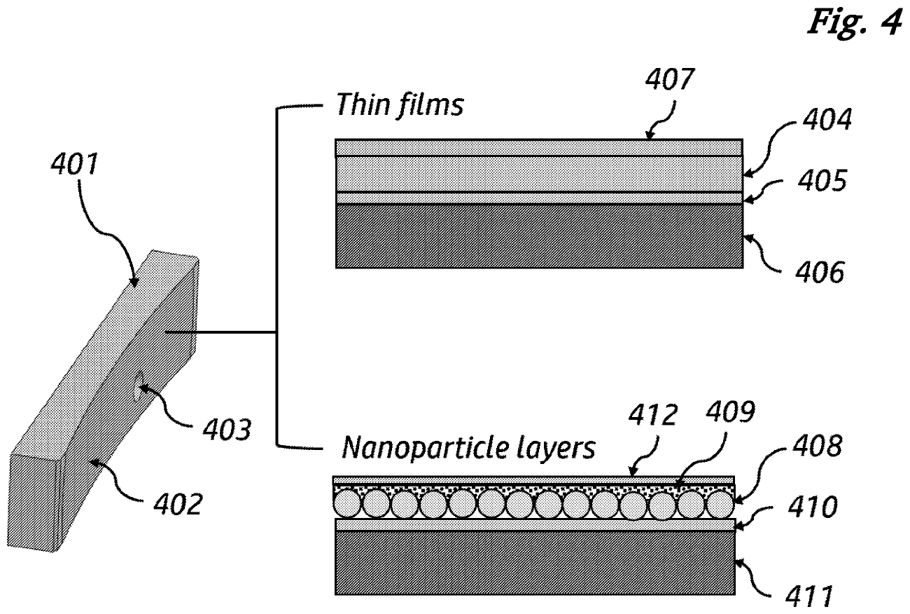

The coating structures are illustrated through FIG. 4. The mirror substrate 401 can be made of fused silica or any other suitable material. The transmission substrate is optically transparent to the chosen wavelength of the laser. The aperture 403 can be a physical hole or an optically transparent region in the mirror. The reflection and transmission coating 402 may be a thin film and/or nanoparticle layer containing Pd or an alloy of Pd. A thin film-only construction is relatively straightforward and inexpensive. Such a reflective coating is made of multiple layers of materials (404, 405, 407) deposited on a substrate 406 e.g., fused silica. The layer 405 is the thin adhesion layer e.g., Ti or Ni for the adhesion of the other layers over it. This layer is not mandatory for all material combinations. The layer 404 is a layer of Pd or any of its alloys with Au, Co, Ta, Hf, Cu, etc. This layer acts as the primary hydrogen sensitive element in the MHPOC. The layer 407 is the top layer made of a polymer such as polymethyl methacrylate (PMMA). This layer reduces the cross species-sensitivity and poisoning of the layer 404 while also allowing for the diffusion of H₂. An alternative coating structure includes a nanoparticle layer 408. This coating can be more responsive for both reflection and transmission and is preferred for the transmission windows. The nanoparticle layer can be made of nano-patchy particle arrays. This layer greatly enhances the hydrogen sensitivity of the MHPOC. This layer is covered by the layer 409 of much smaller Pd-alloy nanoparticles typically in the range of ˜2-20 nm in total thickness, forming the primary sensing element. This layer can be further coated with a layer 412, typically a polymer e.g., PMMA to reduce cross-species interference and poisoning. When the Pd-alloy layer is covered by a 30-nm TAF (Teflon AF 2400) layer, the response time of the sensor is significantly enhanced.

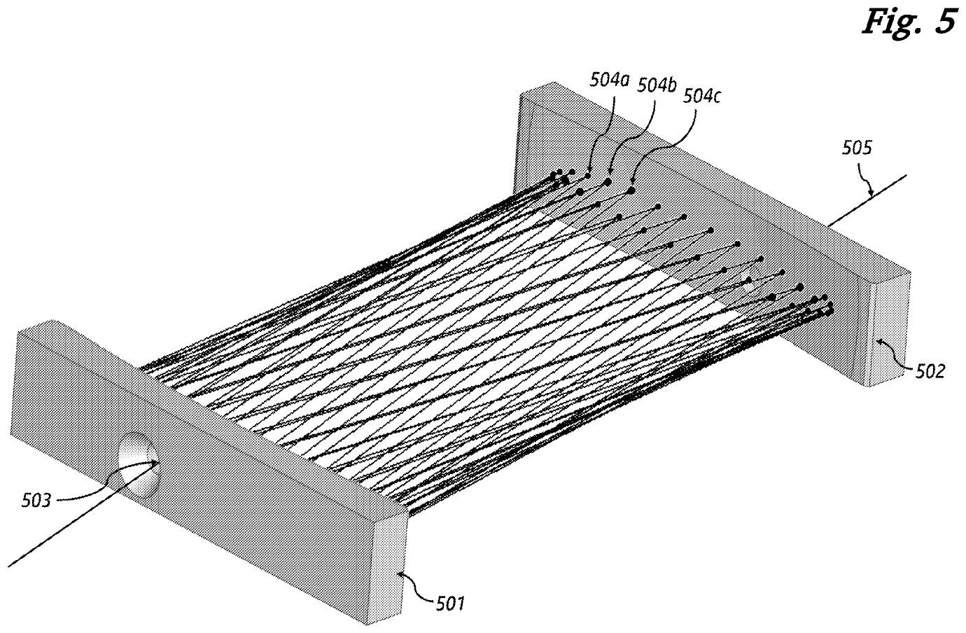

FIG. 5 illustrates the path of a light beam in a MHPOC, according to an embodiment of the invention. In this embodiment, the MHPOC has two mirrors 501 and 502, facing each other. The laser beam enters the MHPOC through the physical aperture 503. The beam then continues to bounce 66 times within the cavity interacting with the reflective coating containing Pd at the spots including three spots 504a, 504b, 504c. Following that the beam exits the MHPOC following the path 505. The hydrogen contrast of this embodiment is given by eq. (1) with n=66, i.e.,

$$HC = \frac{Δ I}{I} = {( {R}_{0} )}^{66} - {( {R}_{H} )}^{66} \qquad ( 4 )$$

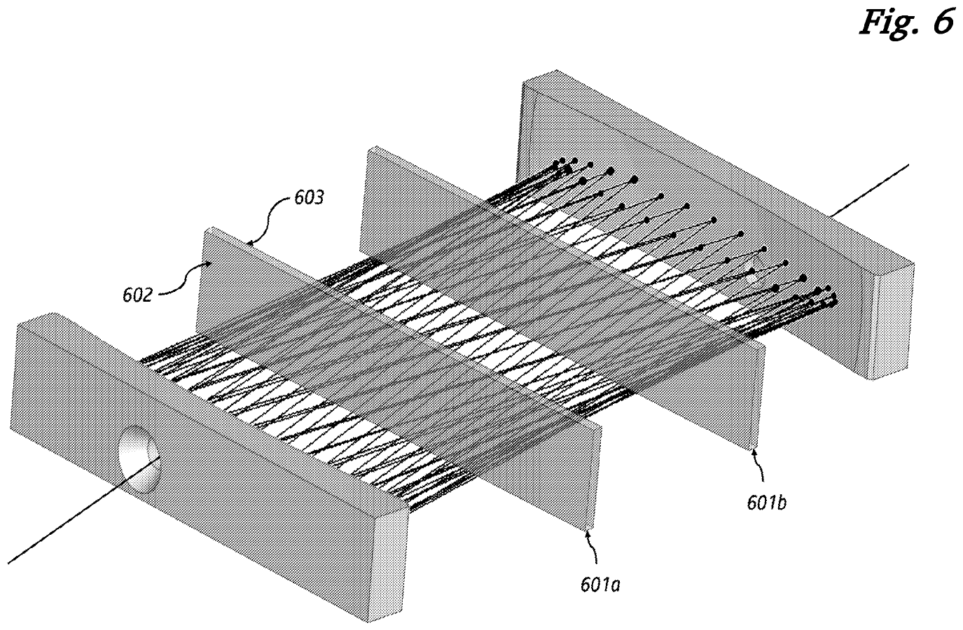

FIG. 6 shows another embodiment, wherein two transmission windows 601a, 601b are inserted into the cavity shown in FIG. 5. Both surfaces 602 and 603 of 601a are coated with nanoparticles to enhance the MHPOC sensitivity. The hydrogen contrast is given by eq. (2) with n=66 and n_{T}=2, i.e.,

$$HC = \frac{Δ I}{I} = {( {T}_{0}^{2} {R}_{0} )}^{66} - {( {T}_{H}^{2} {R}_{H} )}^{66} \qquad ( 5 )$$

To calibrate the system, the optical cell may be partially evacuated periodically to measure the baseline intensity I without hydrogen present. Comparison of this partially evacuated intensity with an atmospheric sample intensity I_{H} allows the determination of ΔI=I−I_{H}. The ratio ΔI/I provides hydrogen partial pressure. This method is slower than if the contrast modulation were to be created via other means, but can be quite effective. This pressure effect can also be replaced by thermal effect since hydrogen absorption is dependent on temperature. The amount of hydrogen arrested inside the Pd lattice is significantly changed if the temperature changes. Therefore, if the temperature of the medium is modulated, this will lead to an intensity change only if hydrogen is present if the thermal effects do not lead to significant optical distortion. The temperature of the glass slides can be changed faster than the pressure in the MHPOC. The temperature effect is, however, possibly going to need periodic calibration.

One important consideration for embodiments including a transmission slide inside the optical cavity is the fact that overall laser beam power drops with every pass. For example, an uncoated BK-7 glass slide transmits only 92% of the incident light at 633 nm. For 66 reflections and one transmission slide, this leads to only 0.4% of the light output as compared to the cavity without the slides. The rest of the light is reflected as stray reflections within the cavity which can also lead to fringing noise or etaloning effects. To achieve the ultra-low limit of detection (LOD), the limit of ΔT«T₀ should be satisfied. Such condition would be achieved if T₀ is close to unity and ΔT is small. While the absorption of the PS monolayer and polymer coatings is negligible, the absorption of the glass substrate is usually large due to the different refractive indices between the glass substrate and air. To mitigate such losses, preferred embodiments include a thin anti reflection layer (e.g., TiO₂/SiO₂—TiO₂) on the transmission slide. As a result, the transmittance through the glass substrate at a certain wavelength can reach 99%. A small ΔT can be achieved by using the PdₓCo₁₀₀₋ₓ coating with several nm thickness. The transmission reduces by 7% at 1000 nm wavelength when a thin Pd layer of 2 nm is used. The thin PdₓCo₁₀₀₋ₓ coating also ensures that T₀ is close to unity and sensors have a fast response. This can be also achieved through application of a nanotextured surface by dry/wet etching or molding processes.

The coatings incorporating nanospheres will now be discussed in more detail. In one implementation, PdₓCo₁₀₀₋ₓ nano-patchy (NP_{D}) arrays may be fabricated on polystyrene (PS) nanosphere arrays with diameter D=500 nm and 200 nm using nanosphere lithography (NL) together with the glancing angle co-deposition (GLACD) technique. In GLACD, the Pd and Co vapor rates can be independently controlled by two electron-beam sources at 10⁻⁷ torr. The combination of the incident angle θ and azimuthal angle φ yields nanostructures with different shapes and sizes. The alloy formation and composition are confirmed experimentally by the energy-dispersive X-ray spectroscopy (EDS) elemental mapping. A vapor incident angle θ=50° was chosen to ensure that the film would not be deposited onto the glass substrate. A hysteresis-free response ensures that the accuracy of the sensor is better than 3%. Generally, Pd₈₀Co₂₀ has a faster response time (below 1 s in the range) but smaller sensitivity than Pd₈₀Ag₂₀ and Pd₈₀Au₂₀ at the same condition. When more Co element is used, the Pd₆₇Co₃₃ NP₂₀₀ shows better resistance to the humidity. In preferred embodiments, sensors with ppb levels of LOD and fast response time using arrays of nano-patches are made using PdₓM₁₀₀₋ₓ alloy (M=Ag or Co) as the coating material. There are several advantages of using an array of PS nanospheres as a substrate: (1) such structures are very useful for the optical transmission readout because the thickness, shape, and morphology of the structures can be controlled by PS bead size, incident angle θ as shown in FIG. 4a, and deposition thickness; (2) due to fast hydrogen diffusion in PS, the hydrogen can interact with the sensing composite through the substrate site. Therefore, the surface-to-volume ratio (SVR) is almost doubled in this structure in comparison to the deposition on glass or Si substrates, thus accelerating the H₂ sorption/desorption process. The unique design of the nano-patchy sensor allows for a very high surface coverage (>90%) and results in sizable optical contrast even at very low V_{H}_{₂}. The curvature of the patches and their loose connection with the PS bead mitigate the substrates effect and allow fast response time and better mechanical stability upon the lattice expansion and contraction.

In order to obtain a faster H₂ sensor with higher sensitivity and selectivity, it is preferred to use a polymer coating on the nanostructures, e.g., PMMA and/or PTFE. The PMMA layer is known to filter the gases that are poisonous to the hydrides and is used as an outer layer, while the PTFE layer modifies the surface energy of metal alloys for faster H₂ absorption kinetics. In principle, a layer of less than 0.1 μm of PMMA and PTFE coating should not have a noticeable effect on the response time. The PMMA layer may be deposited by a spin-coating technique and the PTFE may be deposited in an evaporation system at a base pressure of 10⁻⁷ torr.

We now discuss the choice of operational wavelength. Reflectivity of Palladium increases steadily with larger wavelengths. However, the absorption of the polymer layer used for increasing selectivity to hydrogen also increases with larger wavelengths. The preferred operational wavelength is selected by balancing these trade-offs.

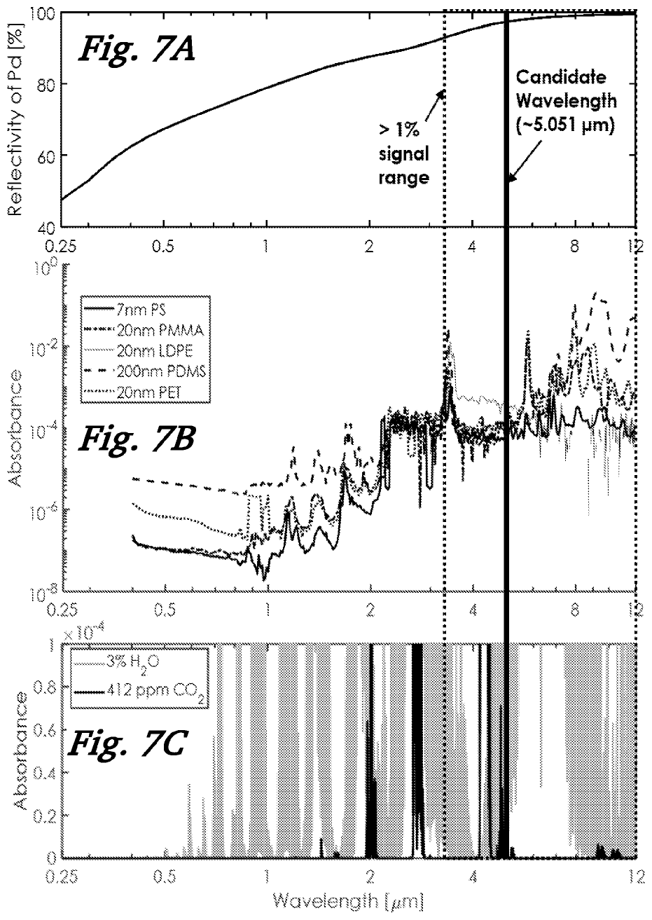

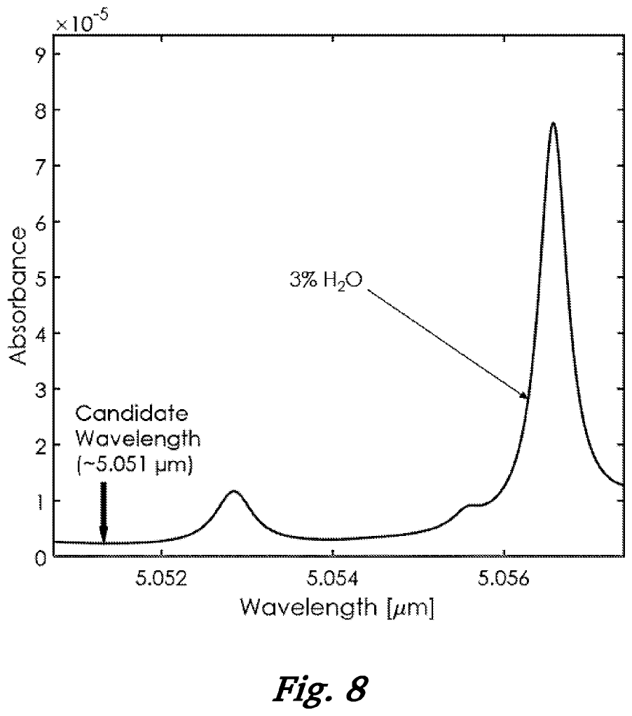

The total light output at the cavity outlet is exponentially dependent on the reflectivity of the mirrors. Pd reflectivity increases significantly in the infrared as predicted by the Lorentz-Drude model (FIG. 7A), improving the total light intensity obtainable at the cavity outlet. The wavelength dependence of the reflectivity of different coatings in the mid- to far-infrared is used. For example, the 66-reflection Zephyr cavity of FIG. 5 will lead to only 1% of the laser intensity at the output for a reflectivity of 93.26%. This threshold is indicated by the dotted line indicated by the label >1% signal range in FIG. 7A and occurs at around 3.42 μm. A polymer coating may be applied on the mirror to significantly enhance its selectivity to hydrogen absorption. FIG. 7B shows the calculated absorbances of different thin-film compatible polymers for previously achieved coating thicknesses. As can be seen, the extinction of light in the polymer layer has a roughly similar trend as Pd reflectivity with wavelength. This implies that the trade-off between increased reflectivity must be managed against the extinction from the selectivity-enhancing polymer coating. Not only that, the selectivity of the sensor also hinges on selectivity against light absorption in the laser path due to direct absorption from atmospheric gases. FIG. 7C shows the simulated infrared spectrum of H₂O, CO₂ in the 0.25-12 μm wavelength range using the HITRAN database. This competition from other atmospheric gases narrows down the pool for the choice of wavelength quite significantly. Several other molecules such as various hydrocarbons, carbon monoxide, nitrogen oxides, etc. are also potential interference. All these factors led to the choice of a preferred wavelength of 5.051 μm for embodiments with these materials, as shown in FIG. 8. The calculated reflectivity of Pd at this wavelength is 0.973 and the absorbance from a 20 nm PMMA top layer is 1.8×10⁻⁴. For the 66-reflection cavity, a healthy 16% light output is expected at the cavity outlet. Preferably, a mid-infrared laser (quantum cascade and interband cascade lasers) near that wavelength region is used. The infrared reflectivity properties of PdHx may be further determined using a Fourier Transform Infrared Spectrometer (FTIR). In summary, the reflective component could benefit from an operational wavelength selected above 3.4 μm for a pure Pd mirror. However, this can change for an alloy of Pd and Au, for example.

The transmission of light through ultra-thin layers of Pd is much more forgiving when it comes to the wavelength selection. The choice is therefore mainly dependent on wavelength-sensitivity of the various layer thicknesses of the Pd-alloys. Mass-manufactured visible or telecom near infrared diode lasers (600-1800 nm) may be used for the transmission use-case.

1. A device for measuring a concentration of hydrogen in a gas sample, the device comprising:
a multipass optical cavity comprising optical elements, wherein the optical elements include mirrors supporting a multipass optical pathway within an interior of the multipass optical cavity;
a laser configured to generate a laser beam entering the multipass optical cavity and propagating along the multipass optical pathway within the interior of the multipass optical cavity such that the laser beam reflects multiple times from the mirrors of the multipass optical cavity;
a detector configured to detect an intensity of the laser beam exiting the multipass optical cavity; and
a signal processor configured to determine the concentration of hydrogen in the gas sample in the optical cavity from a measured intensity of the laser beam;
wherein the multipass optical cavity comprises surface layers containing Pd on the optical elements; whereby hydrogenation of the surface layers containing Pd by the hydrogen in the gas sample alters optical properties of the surface layers containing Pd to allow optical detection of hydrogen.

2. The method of claim 1 wherein the surface layers containing Pd are on the mirrors.

3. The method of claim 1 wherein the laser beam reflects at least 10 times from the mirrors of the multipass optical cavity.

4. The method of claim 1 wherein the optical elements include a transmissive window positioned between the mirrors to intersect the multipass optical pathway.

5. The method of claim 1 wherein the optical elements include a transmissive window, and wherein the surface layers containing Pd are on at least one surface of the transmissive window.

6. The method of claim 1 wherein the multipass optical cavity is contained in a cell having porous walls configured to facilitate diffusion-based sampling and reduce particulate entrainment.

7. The method of claim 1 wherein the multipass optical cavity is contained in a sealed gas chamber.

8. The method of claim 7 wherein the sealed gas chamber contains a particulate filter or interfering gas-reduction catalysts to prevent degradation of optical surfaces and reduce cross-species interference.

9. The method of claim 1 wherein the surface layers containing Pd comprise a Pd alloy with Au, Co, Ta, Ti, or Hf.

10. The method of claim 1 wherein the surface layers containing Pd comprise nanoparticles or polymer coatings.

11. The method of claim 1 wherein the laser beam has a wavelength in the range 400-1000 nm.

12. The method of claim 1 wherein the surface layers containing Pd have thicknesses of 30 nm or 20 nm.

13. The method of claim 1 wherein the laser beam has a wavelength in the range 1000-8000 nm.

14. The method of claim 1 wherein the surface layers containing Pd have thicknesses in the range 5 nm-200 nm.

15. The method of claim 1 wherein the surface layers containing Pd comprise a Pd alloy with Co or Au.

16. The method of claim 1 wherein the transmissive window is a contrast enhancement slide.

17. The method of claim 1 wherein the laser beam reflects at least 5 times from the mirrors of the multipass optical cavity.

18. The method of claim 1 wherein the laser beam reflects 66 times from the mirrors of the multipass optical cavity.

19. The method of claim 1 wherein the laser beam has a wavelength of 5.051 μm.

20. The method of claim 1 wherein the laser is a mid-infrared laser.

21. The method of claim 1 wherein the laser is a diode laser, a quantum cascade laser, or an interband cascade laser.

22. The method of claim 1 wherein the surface layers containing Pd comprise a 160 nm layer of a Pd alloy with Co or Au.

23. The method of claim 1 wherein the transmissive window is a semi-transparent glass slide coated with a nanoparticle layer containing Pd or an alloy with Au, Ti, Co, Ta, Hf, or W.

24. The method of claim 1 wherein the transmissive window comprises an anti-reflective coating.

25. The method of claim 1 wherein the transmissive window comprises a PdₓCo₁₀₀₋ₓ coating, where x is in the range 50-100.

26. The method of claim 1 wherein the transmissive window comprises a 2 nm thickness layer of Pd or its alloy.

27. The method of claim 1 wherein the transmissive window comprises nanoparticles or nanostructures with diameters in the range 50 nm-1000 nm.

28. The method of claim 1 wherein the transmissive window comprises a polymer coating of PMMA and/or PTFE.

29. The method of claim 1 wherein the transmissive window comprises a polymer coating less than 100 nm thick.

30. The method of claim 1 wherein the laser beam has a wavelength of 1300 nm or 1550 nm.
